(19) United States
(12) Patent Application Publication
(10) Pub. No.: US 2026/0293913 A1
(43) Pub. Date: Oct. 1, 2026

(54) APPLICATION OF BORAGE EXTRACT IN PROMOTING PLANT GROWTH AND/OR REGULATING PLANT STRESS RESISTANCE

(71) Applicant: CHENGDU NEWSUN CROP SCIENCE CO., LTD., Chengdu (CN)

(72) Inventors: Jin HUANG, Chengdu (CN); Huihui WANG, Chengdu (CN); Dan WU, Chengdu (CN); Chuting DU, Chengdu (CN); Shuai LI, Chengdu (CN); Yuping WANG, Chengdu (CN); Dan REN, Chengdu (CN); Qiming HE, Chengdu (CN)

(21) Appl. No.: 19/680,134

(22) Filed: May 18, 2026

Related U.S. Application Data
(63) Continuation of application No. PCT/CN2024/122129, filed on Sep. 29, 2024.

(30) Foreign Application Priority Data
Nov. 30, 2023 (CN) 202311624771.3

(51) Int. Cl. A01N 65/08; A01P 21/00

(52) U.S. Cl. CPC A01N 65/08; A01P 21/00

(57) ABSTRACT

The present disclosure belongs to the technical field of agriculture, and specifically relates to an application of a borage extract in promoting plant growth and/or regulating plant stress resistance. At present, only the use of borage extract in the medical field has been reported, and it has not been involved in agriculture. The present disclosure provides a novel application of a borage extract, specifically the use thereof as a biostimulant for promoting plant growth and enhancing plant stress resistance.

### TECHNICAL FIELD

The present disclosure belongs to the technical field of agriculture, and specifically relates to an application of a borage extract in promoting plant growth and/or regulating plant stress resistance.

### BACKGROUND

Borage is a strong, annual herbaceous plant belonging to the Borago L. in Boraginaceae family. It is an annual herbaceous plant with a plant height of up to 120 centimeters. The entire plant is covered with coarse, grayish-white trichomes. The stem is cylindrical in shape, the entire plant is approximately 1½ feet tall, and has branches. The branches are hollow and rich in water. The leaves are dark green with wrinkles, growing alternately on the stem; the size of which is about 3 inches long and 1½ inches wide; the leaves stiffly and gradually symmetrically contract and gather together from bottom to top, forming an elliptical spherical shape; the tips of the trichomes covering the upper and lower parts of the leaves and the stems have extremely small round heads, resulting in a continuous wavy edge of the external trichomes of the ellipsoidal spheroid formed by the leaves. The fruits contain four black brown nut kernels. Leaves alternate, rough like cucumber leaves, with stalks. The flowering period is in July, the flowers are blue, scattered, and leafy cyme with a long stalk. The fruits are small nuts, smooth or convexly papillate.

The borage and/or borage extract have/has certain nutritional value and physiological functions, and are/is commonly used in the medical field, mainly including: (1) prevention and treatment of cardiovascular diseases, where the borage and/or borage extract can inhibit the synthesis of angiotensin, thereby lowering blood pressure and reducing the levels of serum cholesterol and triglycerides; (2) treatment of diabetes, where the borage and/or borage extract have/has the effect of lowering blood sugar, enhances the sensitivity of cell membrane receptors to insulin, and protects the stability of insulin in the blood; (3) treatment of cancers; (4) relieving of premenstrual syndrome; (5) treatment of skin diseases; (6) protection of liver; and (7) regulation of immune functions, etc. However, no application of borage extract in promoting plant growth has been found.

### SUMMARY

The present disclosure discovers for the first time that the borage extract not only has a promoting effect on plant growth, but also can enhance the stress resistance of plants, expanding the application range of borage extract, and providing a new choice for regulating plant growth in agriculture.

The present disclosure provides an application of a borage extract in promoting plant growth and/or regulating plant stress resistance.

In the present disclosure, the borage extract is capable of promoting seed germination and/or the growth of one or more of roots, stems, leaves, or flowers and fruits. For example, it is capable of promoting or inhibiting root length, stem thickness, plant height, leaf width, leaf length, leaf quantity, leaf area, biomass, chlorophyll content, yield, etc.

Stress resistance of plants refers to certain traits that plants possess to resist unfavorable environments, such as cold resistance, drought resistance, salt and alkali resistance, high temperature resistance, etc.

In the present disclosure, the stress resistance includes but is not limited to salt and alkali resistance, cold resistance, drought resistance, and high temperature resistance.

In the present disclosure, the borage extract is an alcohol extract.

In the present disclosure, an alcohol solution is selected from methanol, ethanol, and propanol.

In a specific embodiment of the present disclosure, the alcohol solution is ethanol or methanol.

In the present disclosure, the concentration of ethanol or methanol can be selected from 10% to 100%, and can be selected from 10% to 20%, 30% to 40%, 40% to 50%, 50% to 60%, 60% to 70%, 70% to 80%, and 90% to 100%, and can also be selected from . . . 30%, 40%, . . . 50%, 60%, . . . 70%, . . . 80%, etc.

Further, the concentration of the ethanol is 40% to 80%.

In the present disclosure, the mass ratio of the borage to the ethanol is 1-5:15-25.

In a specific embodiment of the present disclosure, the mass ratio of the borage to the ethanol is 1:20.

When the mass ratio or other values or parameters are expressed as a range, a preferred range, or a range limited by a series of upper and lower preferred values, it should be understood as specifically disclosing all ranges formed by any pairing of any upper limits or preferred values of a range with any lower limits or preferred values of a range, regardless of whether the range is disclosed separately. For example, when a range “1 to 5” is disclosed, the described range should be interpreted as including the range of “1 to 4”, “1 to 3”, “1 to 2”, “1 to 2 and 4 to 5”, “1 to 3 and 5”, etc. When a numerical range is described herein, unless otherwise specified, the range is intended to include its end values and all integers and fractions within that range.

In the present disclosure, the borage extract is used as an active ingredient of a biostimulant, which can be used alone or in combination with other products.

The present disclosure provides a biostimulant, which includes the borage extract as the active ingredient.

The “biostimulant” described in the present disclosure includes substances and/or microorganisms that, when applied to plants or rhizosphere, function to stimulate natural processes to promote and/or inhibit absorption of nutrients, improve and/or reduce the efficiency of nutrient conversion, abiotic tolerance, and crop yield.

In the present disclosure, the borage extract belongs to a natural biostimulant.

The plants described in the present disclosure include but are not limited to economic crops and grain crops such as tobaccos, corns, rices, cucumbers, asparagus lettuces, wheats, capsicum annuums, Brassica rapa chinensis, Lactuca sativa, pakchoi cabbages, tomatoes, citrus, kiwi fruits, cherries, pears, and apples.

The “economic crops” have a wide variety, including but not limited to fiber crops (such as cottons, and hemps), oil crops (such as sesames, and peanuts), sugar crops (such as sugarcanes and sugar beets), hobby crops (such as tobaccos), medicinal crops, dye crops, ornamental crops, fruits (such as citrus, kiwi fruits, cherries, pears, and apples), other economic crops (such as asparagus lettuces, Capsicum annuums, Brassica rapa chinensis, Lactuca sativa, and pakchoi cabbages), etc.

The “grain crops” include but are not limited to cereal crops (such as wheats, rices, and corns), potato crops (including sweet potatoes, potatoes, etc.), and legume crops (including soybeans, broad beans, peas, mung beans, etc.), etc.

In the product of the present disclosure, the borage extract can be directly used as a single agent. To ensure its stability and facilitate transportation and storage, it can be made into agricultural products, for instance, by adding an auxiliary material to prepare into a corresponding dosage form. The auxiliary material can be a conventional auxiliary material in the field, such as a thickener, a defoamer, a dispersant, a wetting agent, a binder, an emulsifier, a stabilizer, and a solvent.

On the other hand, the borage extract described in the present disclosure can be used as a synergist in combination with a product such as a plant regulator, a foliage fertilizer, a water-soluble fertilizer, a compound fertilizer, and a pesticide.

In the present disclosure, the dosage form of the agricultural product includes but is not limited to a powder, a granule, a water aqua, a mother liquor or a mother powder.

In the present disclosure, when in use, a single agent of or an agricultural product prepared from the borage extract is used to treat seeds, spray leaves or irrigate roots.

In the present disclosure, when the borage extract or its products are prepared into a solution for use to promote seed germination or plant growth, the concentration of the borage extract in the solution can be selected according to actual needs.

For example, it can be selected from 0.01-2000 ppm, can be selected from 0.01-1000 ppm, can be selected from 0.01-500 ppm, can also be selected from 0.01 ppm, 0.02 ppm, . . . 0.03 ppm, . . . 1.0 ppm, . . . 2.0 ppm, . . . 3.0 ppm, . . . 1.0 ppm, . . . 2.0 ppm, . . . 3.0 ppm, . . . 10 ppm, . . . 20 ppm, ppm, . . . 30 ppm, etc.

In some specific embodiments of the present disclosure, the concentration of the borage extract is 0.001 ppm to 100 ppm.

In some specific embodiments of the present disclosure, the concentration of the borage extract is 2 ppm to 50 ppm.

The treatment of seeds involves mixing a single agent of or an agricultural product prepared from the borage extract with seeds, coating the seeds with the borage extract, or soaking the seeds to be germinated in the borage extract solution.

In the growth promotion test of the present disclosure, the influence of pests and diseases on plant growth has been excluded. Through such test designs, the results are sufficient to demonstrate that the promotion effect of the borage extract on plant growth is not caused by the avoidance of pests and diseases.

The present disclosure also provides a method for applying a borage extract to promote plant growth and/or regulate plant stress resistance, that is, by applying the borage extract to a plant.

Beneficial effects of the present disclosure are as follows: the present disclosure discovers for the first time that the borage extract can promote plant growth and enhance its stress resistance, expanding the application range of borage extract, and also providing a new choice for regulating plant growth in agriculture.

### DETAILED DESCRIPTION OF THE EMBODIMENTS

The technical solution of the present disclosure will be described clearly and completely below. Obviously, the described embodiments are only part of the embodiments of the present disclosure rather than all of them. Based on the embodiments in the present disclosure, all other embodiments obtained by those of ordinary skill in the art without creative work belong to the scope of protection of the invention.

### Example 1

A certain amount of borage leaves was weighed and ground into powder, 20 volumes of 10% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 1.

### Example 2

A certain amount of borage leaves was weighed and ground into powder, 20 volumes of 20% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 2.

### Example 3

A certain amount of borage leaves was weighed and ground into powder, 20 volumes of 30% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 3.

### Example 4

A certain amount of borage leaves was weighed and ground into powder, 20 volumes of 40% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 4.

### Example 5

A certain amount of borage leaves was weighed and ground into powder, 20 volumes of 50% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 5.

### Example 6

A certain amount of borage leaves was weighed and ground into powder, 20 volumes of 60% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 6.

### Example 7

A certain amount of borage leaves was weighed and ground into powder, 20 volumes of 70% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 7.

### Example 8

A certain amount of borage leaves was weighed and ground into powder, 20 volumes of 80% ethanol were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 8.

### Example 9

A certain amount of borage leaves was weighed and ground into powder, 20 volumes of 90% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 9.

### Example 10

A certain amount of borage leaves was weighed and ground into powder, 20 volumes of 100% ethanol solution were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 10.

### Example 11

A certain amount of borage leaves was weighed and ground into powder, 20 volumes of 100% methanol were added, and sonicated at room temperature for 30 minutes, the above operations were repeated twice, the filtrates were combined, and concentrated under reduced pressure to 1:2 (i.e., 1 g of medicinal material corresponded to 2 g of extract) to obtain Borage Extract 11.

### Test Example 1

This test example tested the effects of the borage extracts obtained by different extraction methods on the growth of Brassica rapa chinensis seedlings using pot cultivation methods. The method for using the borage extract in this test example was foliar spraying.

### 1. Test Method

### (1) Test Sample

The borage extract in ethanol (prepared in Examples 1 to 10) and the borage extract in methanol (prepared in Example 11) were all prepared into a 1% mother liquor (i.e. 10000 ppm) using pure water, and were diluted and applied according to the test design after filter sterilization

### (2) Test Design

A total of 34 groups of treatments were designed in the test, with each group repeated 8 times. For details, please refer to Table 1.

TABLE 1
Test Design

| | | Concentration |
|---|---|---|
| Nos. | Extraction Method | (ppm) |
| CK | / | / |
| 1 | Borage extract extracted with 10% ethanol (Borage Extract 1) | 2, 10, 50 |
| 2 | Borage extract extracted with 20% ethanol (Borage Extract 2) | 2, 10, 50 |
| 3 | Borage extract extracted with 30% ethanol (Borage Extract 3) | 2, 10, 50 |
| 4 | Borage extract extracted with 40% ethanol (Borage Extract 4) | 2, 10, 50 |
| 5 | Borage extract extracted with 50% ethanol (Borage Extract 5) | 2, 10, 50 |
| 6 | Borage extract extracted with 60% ethanol (Borage Extract 6) | 2, 10, 50 |
| 7 | Borage extract extracted with 70% ethanol (Borage Extract 7) | 2, 10, 50 |
| 8 | Borage extract extracted with 80% ethanol (Borage Extract 8) | 2, 10, 50 |
| 9 | Borage extract extracted with 90% ethanol (Borage Extract 9) | 2, 10, 50 |
| 10 | Borage extract extracted with 100% ethanol (Borage Extract | 2, 10, 50 |
| | 10) | |
| 11 | Borage extract extracted with 100% methanol (Borage Extract | 2, 10, 50 |
| | 11) | |

### (3) Test Procedure

### 1) Preparation of Test Materials for Brassica Rapa Chinensis

An equal weight (400 g) of vermiculite and coconut coir sterilized by high-pressure steam at 121° C. for 20 minutes were weighed and mixed evenly in a ratio of 2:1, and then put into a pot for later use. The seeds of Brassica Rapa Chinensis were soaked and sterilized in a 5% sodium hypochlorite solution for 10 minutes, washed with water for 5-6 times, and then sowed; when the Brassica rapa chinensis seedlings grew to have three leaves and one heart, seedlings of the same size, free from pests and diseases were selected, and field planted for later use.

### 2) Preparation of Agents

The 1% mother liquors prepared by extracting and concentrating the borage extracts with different solvents were diluted by 200 times, 1000 times, and 5000 times, respectively, to obtain the agents of 50 ppm, 10 ppm, and 2 ppm.

### 3) Test Treatments

The plump Brassica rapa chinensis seedlings of the same size, free from pests and diseases were selected and transplanted into pots, with one seedling per pot and 8 replicates per treatment. The seedlings were acclimatized for 3 days, and a total of 272 pots was tested. After acclimatization, each germination box was irrigated with 50 mL of the agent solution according to the test design, while the control box was irrigated with clear water. The indicators were investigated 7 days after treatment.

### (4) Detection Indicators

The test detection indicators included chlorophyll, leaf area, fresh weight of overground parts, and dry weight of overground parts.

### 2. Result Analysis

(1) the Effect of Borage Extracts Extracted in Different Ways on SPAD Value of Brassica rapa chinensis

As shown in Table 2, compared with the clear water control, the SPAD values of Brassica rapa chinensis leaves were all increased by root application of different borage extracts. It was found from comparison that under different concentrations of treatment, the growth rate of SPAD value of Brassica rapa chinensis treated with borage extracts extracted with 50% to 70% ethanol was relatively high, reaching a maximum of 31.25%.

TABLE 2
Effect of Different Borage Extracts on
SPAD Value of Brassica Rapa Chinensis

| | SPAD Value | | | | | |
|---|---|---|---|---|---|---|
| | 2 | Growth | 10 | Growth | 50 | Growth |
| Treatment | ppm | rate | ppm | rate | ppm | rate |
| CK | | | | 22.4 | | |
| 10% ethanol | 24.3 | 8.48% | 25.3 | 12.95% | 24.3 | 8.48% |
| 20% ethanol | 26.3 | 17.41% | 27.1 | 20.98% | 26.7 | 19.20% |
| 30% ethanol | 25.6 | 14.29% | 26.4 | 17.86% | 28.1 | 25.45% |
| 40% ethanol | 26.4 | 17.86% | 28.4 | 26.79% | 27.4 | 22.32% |
| 50% ethanol | 27.4 | 22.32% | 28.9 | 29.02% | 28.6 | 27.68% |
| 60% ethanol | 27.7 | 23.66% | 29.4 | 31.25% | 29.1 | 29.91% |
| 70% ethanol | 28.1 | 25.45% | 27.4 | 22.32% | 28.4 | 26.79% |
| 80% ethanol | 26.4 | 17.86% | 26.3 | 17.41% | 27.6 | 23.21% |
| 90% ethanol | 27.1 | 20.98% | 27.1 | 20.98% | 28.8 | 28.57% |
| 100% ethanol | 25.4 | 13.39% | 26.4 | 17.86% | 26.1 | 16.52% |
| 100% methanol | 26.6 | 18.75% | 27.6 | 23.21% | 26.7 | 19.20% |

(2) the Effect of Different Borage Extracts on Fresh and Dry Weights of Overground Parts of Brassica rapa chinensis

As shown in Tables 3 and 4, the fresh and dry weights of overground parts of Brassica rapa chinensis showed consistent trends. The biomass of Brassica rapa chinensis was increased to varying degrees by treatment with different borage extracts compared with the clear water control. Among them, the fresh weights of overground parts of Brassica rapa chinensis treated with the borage extract in 60% ethanol at three concentrations were higher than other treatments, with the highest growth rate reaching 30.33%. By the treatment with the borage extract in 60% ethanol at 10 ppm, the growth rate of the dry weight of overground parts was the highest, reaching 27.52%.

TABLE 3
Effect of Different Borage Extracts on Fresh Weight
of Overground Parts of Brassica Rapa Chinensis

| | Fresh Weight of Overground Parts (g) | | | | | |
|---|---|---|---|---|---|---|
| | 2 | Growth | 10 | Growth | 50 | Growth |
| Treatment | ppm | rate | ppm | rate | ppm | rate |
| CK | | | | 2.10 | | |
| 10% ethanol | 2.27 | 8.10% | 2.33 | 10.95% | 2.31 | 10.00% |
| 20% ethanol | 2.31 | 10.00% | 2.40 | 14.29% | 2.45 | 16.67% |
| 30% ethanol | 2.26 | 7.62% | 2.38 | 13.33% | 2.41 | 14.76% |
| 40% ethanol | 2.44 | 16.19% | 2.54 | 20.95% | 2.57 | 22.38% |
| 50% ethanol | 2.61 | 24.29% | 2.67 | 27.14% | 2.66 | 26.67% |
| 60% ethanol | 2.64 | 25.71% | 2.71 | 29.05% | 2.73 | 30.00% |
| 70% ethanol | 2.54 | 20.95% | 2.54 | 20.95% | 2.64 | 25.71% |
| 80% ethanol | 2.50 | 19.05% | 2.61 | 24.29% | 2.68 | 27.62% |
| 90% ethanol | 2.44 | 16.19% | 2.57 | 22.38% | 2.61 | 24.29% |
| 100% ethanol | 2.26 | 7.62% | 2.51 | 19.52% | 2.54 | 20.95% |
| 100% methanol | 2.69 | 28.10% | 2.64 | 25.71% | 2.54 | 20.95% |

TABLE 4
Effect of Different Borage Extracts on Dry Weight
of Overground Parts of Brassica Rapa Chinensis

| | Dry Weight of Overground Parts (g) | | | | | |
|---|---|---|---|---|---|---|
| | 2 | Growth | 10 | Growth | 50 | Growth |
| Treatment | ppm | rate | ppm | rate | ppm | rate |
| CK | | | | 0.109 | | |
| 10% ethanol | 0.121 | 11.01% | 0.118 | 8.26% | 0.122 | 11.93% |
| 20% ethanol | 0.124 | 13.76% | 0.124 | 13.76% | 0.119 | 9.17% |
| 30% ethanol | 0.112 | 2.75% | 0.122 | 11.93% | 0.121 | 11.01% |
| 40% ethanol | 0.124 | 13.76% | 0.136 | 24.77% | 0.131 | 20.18% |
| 50% ethanol | 0.123 | 12.84% | 0.133 | 22.02% | 0.133 | 22.02% |
| 60% ethanol | 0.127 | 16.51% | 0.139 | 27.52% | 0.136 | 24.77% |
| 70% ethanol | 0.126 | 15.60% | 0.124 | 13.76% | 0.128 | 17.43% |
| 80% ethanol | 0.128 | 17.43% | 0.13 | 19.27% | 0.129 | 18.35% |
| 90% ethanol | 0.125 | 14.68% | 0.128 | 17.43% | 0.132 | 21.10% |
| 100% ethanol | 0.117 | 7.34% | 0.131 | 20.18% | 0.127 | 16.51% |
| 100% methanol | 0.124 | 13.76% | 0.128 | 17.43% | 0.125 | 14.68% |

(3) Effect of Different Borage Extracts on Leaf Area of Brassica rapa chinensis

As shown in Table 5, the leaf area of Brassica rapa chinensis leaves was significantly increased after being treated with different borage extracts. The growth rate of the leaf area was more significant by the treatment with extracts extracted with 50% to 60% ethanol than other treatments. Among them, the growth rate of the leaf area reached 38.00% by the treatment with extracts extracted with 50% ethanol at 10 ppm, secondly the growth rate of the leaf area at different concentrations reached 33.33%, 36.67%, and 29.98% by the treatment with extracts extracted with 60% ethanol, respectively.

TABLE 5
Effects of Different Borage Extracts on
Leaf Area of Brassica Rapa Chinensis

| | Leaf Area (cm²) | | | | | |
|---|---|---|---|---|---|---|
| | 2 | Growth | 10 | Growth | 50 | Growth |
| Treatment | ppm | rate | ppm | rate | ppm | rate |
| CK | | | | 55.71 | | |
| 10% ethanol | 64.58 | 15.92% | 68.48 | 22.92% | 67.41 | 21.00% |
| 20% ethanol | 66.71 | 19.75% | 67.24 | 20.70% | 65.88 | 18.26% |
| 30% ethanol | 68.74 | 23.39% | 71.77 | 28.83% | 71.23 | 27.86% |
| 40% ethanol | 74.11 | 33.03% | 74.58 | 33.87% | 70.45 | 26.46% |
| 50% ethanol | 72.45 | 30.05% | 76.88 | 38.00% | 72.88 | 30.82% |
| 60% ethanol | 74.28 | 33.33% | 76.14 | 36.67% | 72.41 | 29.98% |
| 70% ethanol | 70.14 | 25.90% | 75.45 | 35.43% | 71.85 | 28.97% |
| 80% ethanol | 69.88 | 25.44% | 69.13 | 24.09% | 69.49 | 24.74% |
| 90% ethanol | 71.04 | 27.52% | 68.44 | 22.85% | 70.05 | 25.74% |
| 100% ethanol | 66.76 | 19.83% | 67.18 | 20.59% | 66.83 | 19.96% |
| 100% methanol | 68.92 | 23.71% | 70.15 | 25.92% | 69.12 | 24.07% |

In summary, the borage extracts extracted with different alcohol solvents have a promoting effect on the growth of Brassica rapa chinensis. The SPAD value, leaf area, and biomass of Brassica rapa chinensis leaves have significantly increased. Among them, after being extracted with 50% to 60% ethanol and ultrasonic solvents, the borage extracts had a more prominent growth promoting effect, and performed better under the treatment at 10 ppm.

### Test Example 2

This test example tested the effects of borage extracts in three ethanol solvents that showed good performance in Test Example 1 on germination of corn seeds and growth of seedlings using pot cultivation methods. The method for using the borage extract in this test example was seed soaking.

### 1. Test Method

### (1) Test Sample

The borage extracts extracted with ethanol (prepared in Examples 4, 6 and 8) were all prepared into a 1% mother liquor (i.e. 10000 ppm) using pure water, and were diluted and applied according to the test design after filter sterilization.

### (2) Test Design

A total of 10 groups of treatments were designed in the test, with each group repeated 8 times. For details, please refer to Table 6.

TABLE 6
Test Design

| Nos. | Use of Agents | Concentration (ppm) |
|---|---|---|
| CK | Clear water | / |
| 1 | Borage extract extracted with 40% | 2, 10, 50 |
| | ethanol | |
| 2 | Borage extract extracted with 60% | 2, 10, 50 |
| | ethanol | |
| 3 | Borage extract extracted with 80% | 2, 10, 50 |
| | ethanol | |

### (3) Test Steps:

### 1) Preparation of Culture Medium

An equal weight (350 g) of vermiculite sterilized by high-pressure steam at 121° C. for 20 minutes was weighed and put into a pot for later use, a total of 80 pots. 200 mL of clear water was added to each pot and mixed thoroughly through stirring for later use.

### 2) Seed Soaking Treatment

The prepared mother liquors of borage extract were diluted by 5000 times, 1000 times, and 200 times, respectively to obtain the seed soaking solutions of 2 ppm, 10 ppm, and 50 ppm. 100 g of corn seeds was selected for each treatment and placed in a culture box, 200 mL of seed soaking solution was measured and added to the culture box containing the seeds, mixed thoroughly with the seeds until the seeds were completely soaked in the agent solution, and treated at room temperature for 24 hours. After the corn seeds soaked for 24 hours were rinsed with clear water, they were bunch planted to the culture medium, with 20 seeds per pot, that is, 100 corn seeds were bunch planted per treatment. The test results were investigated after 5 days.

### (4) Investigation Indicators

The test investigation indicators included germination rate, root length, fresh weight of roots, plant height, and fresh weight of plants.

### 2. Result Analysis

### (1) the Effect of Soaking Corn Seeds in Different Borage Extracts on the Germination Rate of Corn

As can be seen from Table 7, the germination rate of corn was increased after soaking the seeds with borage extracts in 40% to 80% ethanol at 2, 10, and 50 ppm. Among them, the best performance was achieved by soaking the seeds with different concentrations of extracts at 10 ppm, and the maximum growth rate of the germination rate reached 33.33%.

TABLE 7
Effect of Soaking Seeds in Borage Extracts on Corn Germination Rate

| Treatment | Concentration | Germination Rate % | Growth Rate % |
|---|---|---|---|
| CK | / | 70.00 | / |
| Extraction with 40% ethanol | 2 ppm | 86.67 | 23.81 |
| | 10 ppm | 93.33 | 33.33 |
| | 50 ppm | 86.67 | 23.81 |
| Extraction with 60% ethanol | 2 ppm | 90.00 | 28.57 |
| | 10 ppm | 90.00 | 28.57 |
| | 50 ppm | 90.00 | 28.57 |
| Extraction with 80% ethanol | 2 ppm | 83.33 | 19.05 |
| | 10 ppm | 90.00 | 28.57 |
| | 50 ppm | 83.33 | 19.05 |

### (2) the Effect of Soaking Seeds in Different Borage Extracts on the Growth of Corn Seedlings

As can be seen from Tables 8 and 9, different borage extracts have a consistent trend in their effects on the growth of overground parts and root systems of corn, and have significant growth promoting effects at different concentrations.

As a whole, after the treatment with various borage extracts, the performance of each indicator was better with the treatment at 10 ppm, the highest growth rates of each indicator reached 17.48%, 34.81%, 23.32%, and 17.57%, respectively; and the performance under the conditions of extraction with 60% ethanol was best.

TABLE 8
Effects of Treatment with Borage Extracts on
Changes in Corn Root Length and Plant Height

| | | Root Length | Growth | Plant Height | Growth |
|---|---|---|---|---|---|
| Treatment | Concentration | (cm) | Rate % | (cm) | Rate % |
| CK | / | 13.42 | / | 8.33 | / |
| Extraction with 40% | 2 ppm | 15.11 | 12.59 | 9.74 | 16.93 |
| ethanol | 10 ppm | 16.82 | 25.34 | 9.99 | 19.93 |
| | 50 ppm | 15.71 | 17.06 | 9.34 | 12.12 |
| Extraction with 60% | 2 ppm | 15.54 | 15.80 | 10.34 | 24.13 |
| ethanol | 10 ppm | 17.48 | 30.25 | 11.23 | 34.81 |
| | 50 ppm | 15.45 | 15.13 | 10.73 | 28.81 |
| Extraction with 80% | 2 ppm | 16.02 | 19.37 | 9.78 | 17.41 |
| ethanol | 10 ppm | 17.14 | 27.72 | 10.00 | 20.05 |
| | 50 ppm | 15.73 | 17.21 | 10.12 | 21.49 |

TABLE 9
Effects of Treatment with Borage Extracts on Changes in Corn Root Weight and Plant Weight

| | | Root Weight | | Plant Weight | |
|---|---|---|---|---|---|
| Treatment | Concentration | (g) | Growth Rate % | (g) | Growth Rate % |
| CK | / | 2.83 | / | 1.48 | / |
| Extraction with 40% | 2 ppm | 3.32 | 17.31 | 1.52 | 2.70 |
| ethanol | 10 ppm | 3.37 | 19.08 | 1.55 | 4.73 |
| | 50 ppm | 3.12 | 10.25 | 1.55 | 4.73 |
| Extraction with 60% | 2 ppm | 3.44 | 21.55 | 1.61 | 8.78 |
| ethanol | 10 ppm | 3.49 | 23.32 | 1.74 | 17.57 |
| | 50 ppm | 3.23 | 14.13 | 1.67 | 12.84 |
| Extraction with 80% | 2 ppm | 3.10 | 9.54 | 1.63 | 10.14 |
| ethanol | 10 ppm | 3.07 | 8.48 | 1.66 | 12.16 |
| | 50 ppm | 3.11 | 9.89 | 1.59 | 7.43 |

### Test Example 3

This test example tested the effects of seed dressing with borage extracts extracted with 60% ethanol that showed good performance in Test Example 2 under salt-alkali conditions on germination of rice seeds and growth of seedlings using pot cultivation methods. The method for using the borage extract in this test example was seed dressing.

### 1. Test Method

### (1) Test Sample

Borage extract extracted with 60% ethanol (prepared in Example 6).

### (2) Test Design

A total of 4 groups of treatments were designed in the test, with each group repeated 5 times. For details, please refer to Table 10.

TABLE 10
Test Design

| | | Concentration |
|---|---|---|
| Nos. | Use of Agents | (g/100 kg seeds) |
| CK | Clear water | / |
| 1 | Borage extract extracted with 60% | 20 |
| | ethanol | |
| 2 | Borage extract extracted with 60% | 100 |
| | ethanol | |
| 3 | Borage extract extracted with 60% | 500 |
| | ethanol | |

### (3) Test Steps:

### 1) Preparation of Culture Medium

An equal weight (100 g) of vermiculite sterilized by high-pressure steam at 121° C. for 20 minutes was weighed and put into a pot for later use, a total of 20 pots. 80 mL of a salt-alkali aqueous solution with a pH of 8.5 prepared from NaOH agent was added to each pot and mixed thoroughly through stirring for later use.

2) Seed dressing treatment: 100 g of rice seeds was weighed and placed in a self-sealing bag for each treatment. According to the test design, the agents required for 100 g of rice seeds were prepared using 20 g/2 L water/100 kg seeds, 100 g/2 L water/100 kg seeds, and 500 g/2 L water/100 kg seeds, and mixed thoroughly with the seeds to ensure that the surface of the seeds was completely covered with the agent solution, then treated at room temperature for 24 hours.

3) After 24 hours of seed dressing, the rice seeds were bunch planted to a backup culture medium according to the test design, 30 seeds were bunch planted per pot, that is, 150 rice seeds were bunch planted per treatment. The test results were investigated after 4 to 5 days.

### (4) Investigation Indicators

The test investigation indicators included germination rate, plant height, and plant weight.

### 2. Result Analysis

(1) the Effect of Seed Dressing Treatment with Borage Extracts on Germination of Rice Seeds

As can be seen from Table 11, under salt-alkali conditions, the germination rate of seeds treated with clear water control was only 55.0%, while the germination rate of rice seeds dressed with borage extracts was significantly increased, the maximum germination rate reached 91.67%, and the maximum growth rate reached 66.67%.

TABLE 11
Effect of Seed Dressing with Borage Extracts under Salt-Alkali Conditions on
Germination Rate of Rice

| Treatment | Concentration | Germination Rate % | Growth Rate % |
|---|---|---|---|
| CK | / | 55.00 | / |
| Borage extract extracted with | 20 g/100 kg | 91.67 | 66.67 |
| 60% ethanol | 100 g/100 kg | 91.67 | 66.67 |
| | 500 g/100 kg | 90.00 | 63.64 |

The salt-alkali conditions inhibited the germination and growth of rice, resulting in slow growth of rice seedlings. After the treatment with clear water, the length of rice seedlings was only 2.01 cm, and the average plant weight per plant was only 24.4 mg. However, after the treatment with borage extract, the length of rice seedlings reached 4.71 cm, with a maximum growth rate of 134.33%, and a maximum growth rate of plant weight of 108.20%, indicating that the seed dressing with borage extract can promote rapid growth of rice seedlings and alleviate the impact of salt-alkali environment on the growth of rice on the basis of promoting normal germination of rice.

TABLE 12
Effect of Seed Dressing with Borage Extracts on Growth
of Rice Seedlings under Salt -Alkali Conditions

| | | Plant | | Plant | |
|---|---|---|---|---|---|
| | | Height | Growth | Weight | Growth |
| Treatment | | (cm) | Rate % | (mg) | Rate % |
| ck | | 2.01 | / | 24.40 | / |
| Borage extract | 20 g/100 kg | 4.32 | 114.93 | 44.60 | 82.79 |
| in 60% | 100 g/100 kg | 4.71 | 134.33 | 50.80 | 108.20 |
| ethanol | 500 g/100 kg | 4.33 | 115.42 | 46.20 | 89.34 |

### Test Example 4

This test example tested the effects of borage extracts extracted with 60% ethanol that showed good performance in Test Example 2 under foliar spray treatment methods on growth of Capsicum annuum seedlings using pot cultivation methods. The method for using the borage extract in this test example was foliage spray.

### 1. Test Method

### (1) Test Sample

The borage extract extracted with 60% ethanol (prepared in Example 6) was prepared into a 1% mother liquor (i.e. 10000 ppm), and was diluted and applied according to the test design after filter sterilization.

### (2) Test Design

A total of 4 groups of treatments were designed in the test, with each group repeated 8 times. For details, please refer to Table 13.

TABLE 13
Test Design

| Nos. | Use of Agents | Concentration (ppm) |
|---|---|---|
| CK | Clear water | / |
| 1-3 | Borage extract extracted | 2, 10, 50 |
| | with 60% ethanol | |

### (3) Test Steps:

### 1) Preparation of Culture Medium

Vermiculite and coconut coir sterilized by high-pressure steam at 121° C. for 20 minutes were mixed evenly in a ratio of 2:1, and then put into a pot for later use.

2) The seeds of Capsicum annuum were soaked and sterilized in a 5% sodium hypochlorite solution for 10 minutes, then washed with water for 5-6 times, and then sowed; when the Capsicum annuum seedlings grew to have 4-5 leaves, seedlings of the same size, free from pests and diseases were selected, and field planted for later use.

### 3) Preparation of Agents

The mother liquor of borage extract extracted with 60% ethanol was diluted by 5000 times, 1000 times, and 200 times, that is the agents of 2 ppm, 10 ppm, and 50 ppm.

### 4) Test Treatments

The Capsicum annuum seedlings of the same size, free from pests and diseases were selected and transplanted into pots, with one seedling per pot and 8 replicates per treatment. A total of 32 pots was tested. After 3 days of acclimatization, the prepared agents were sprayed according to the test design for each treatment until the leaves of Capsicum annuum were evenly covered with the agent solution, but the agent solution did not drip down. For the control, clear water was sprayed. The indicators were investigated 7 days after treatment.

### (4) Detection Indicators

The test inspection indicators included chlorophyll, number of leaves, root length, plant height, root weight, and plant weight.

### 2. Result Analysis

(1) The effect of borage extract treatment on the growth of Capsicum annuum leaves

As can be seen from Table 14, under clear water treatment, the SPAD value of Capsicum annuum leaves was 41.23, while after the treatment with borage extract, the SPAD value of Capsicum annuum leaves reached 48.55 when treated at a concentration of 2 ppm, with a growth rate of 17.75%; after the treatment with borage extract, the number of Capsicum annuum leaves also increased to varying degrees, with a growth rate of 9.62% when treated at 10 ppm.

TABLE 14
Effect of Borage Extract Treatment
on Growth of Capsicum Annuum Leaves

| | | | Growth | Number of | Growth |
|---|---|---|---|---|---|
| Treatment | | SPAD | Rate % | Leaves | Rate % |
| ck | | 41.23 | / | 13.00 | / |
| Extraction with | 2 ppm | 48.55 | 17.75 | 13.75 | 5.77 |
| 60% ethanol | 10 ppm | 47.65 | 15.57 | 14.25 | 9.62 |
| | 50 ppm | 46.85 | 13.63 | 13.75 | 5.77 |

(2) The Effect of Borage Extract Treatment on the Growth of Capsicum annuum Seedlings

As can be seen from Table 15, after the treatment of leaves with borage extract, the growth of overground parts and root systems of Capsicum annuum was promoted to varying degrees, the maximum growth rate reached 32.87%, 19.76%, 34.02%, and 23.54%, respectively. Among them, the performance was better under the treatment at 10 ppm.

TABLE 15
Effect of Borage Extract Treatment on Growth of Capsicum Annuum Seedlings

| | | | Root | Growth | Plant | Growth | Root | Growth | Plant | Growth |
|---|---|---|---|---|---|---|---|---|---|---|
| | | | Length | Rate | Height | Rate | Weight | Rate | Eight | Rate |
| Treatment | | | (cm) | % | (cm) | % | (g) | % | (g) | % |
| ck | | | 12.32 | / | 12.40 | / | 0.97 | / | 4.46 | / |
| Extraction | 2 | ppm | 15.10 | 22.56 | 13.95 | 12.50 | 1.21 | 24.74 | 5.10 | 14.35 |
| with 60% | 10 | ppm | 16.37 | 32.87 | 14.20 | 14.52 | 1.30 | 34.02 | 5.51 | 23.54 |
| ethanol | 50 | ppm | 14.05 | 14.04 | 14.85 | 19.76 | 1.15 | 18.56 | 5.45 | 22.20 |

As a whole, the foliar spray treatment with borage extract can promote higher chlorophyll content and faster growth of leaves in Capsicum annuum seedlings, while it can also promote the growth of plant height and root systems, and it performed better under the treatment at 10 ppm.

### Test Example 5

This test example tested the effects of foliar spray under low-temperature conditions of borage extracts extracted with 60% ethanol that showed good performance in Test Example 2 on growth of cucumber seedlings using pot cultivation methods.

The method for using the borage extract in this test example was foliar spray.

### 1. Test Method

### (1) Test Sample

The borage extract extracted with 60% ethanol (prepared in Example 6) was prepared into a 1% mother liquor (i.e. 10000 ppm), and was diluted and applied according to the test design after filter sterilization.

### (2) Test Design

A total of 4 groups of treatments were designed in the test, with each group repeated 8 times.

For details, please refer to Table 16.

TABLE 16
Test Design

| Nos. | Use of Agents | Concentration (ppm) |
|---|---|---|
| CK | Clear water | / |
| 1-3 | Borage extract extracted | 2, 10, 50 |
| | with 60% ethanol | |

### (3) Test Steps:

1) Preparation of culture medium: vermiculite and coconut coir sterilized by high-pressure steam at 121° C. for 20 minutes were mixed evenly in a ratio of 2:1, and then put into a pot for later use.

2) Preparation of test materials: the seeds of cucumber were soaked and sterilized in a 5% sodium hypochlorite solution for 10 minutes, then washed with water for 5-6 times, and then sowed; when the cucumber seedlings grew to the point where the first true leaf had fully unfolded, seedlings of the same size, free from pests and diseases were selected for later use.

3) Preparation of agent: the mother liquor of the compound extract was diluted by 5000 times, 1000 times, and 200 times, namely 2 ppm, 10 ppm and 50 ppm agents.

### 4) Test Treatments

The cucumber seedlings of the same size, free from pests and diseases were selected and transplanted into pots, with one seedling per pot and 8 replicates per treatment. A total of 32 pots was tested. The prepared agents were sprayed according to the test design for each treatment until the leaves of Brassica rapa chinensis were evenly covered with the agent solution, but the agent solution did not drip down; for the control, clear water was sprayed; after 24 hours of spraying treatment, the seedlings were placed in a low temperature environment of 4° C. for 24 hours, then the wilting of cucumber was observed and the water loss rate was measured.

### (4) Detection Indicators

The test inspection indicator was the water loss rate of cucumber leaves.

The first true leaf of the cucumber after low-temperature treatment was removed, weighed, and the weight A of the leaf was recorded, and then placed in clear water for 12 hours to allow the leaf to fully absorb to saturation, the weight B of the leaf after water absorption was recorded. Leaf water loss rate %=(B−A)/B×100%

### 2. Result Analysis

After the treatment at low temperature (4° C.), severe wilting of cucumber leaves could be observed in the clear water treatment group, while the wilting degree of cucumber leaves was lower after the treatment with borage extract, and there was no obvious curling or softening phenomenon. The low-temperature resistant effect was quantitatively calculated based on the water loss rate of cucumber leaves under low temperature conditions, smaller water loss rate of leaves indicated better low-temperature resistant effect.

As can be seen from the measurement of water loss rate of cucumber leaves, the minimum water loss rate of cucumber leaves after the treatment with borage extract reached 26.34%, which was 36.27% lower than that of clear water treatment, and mainly manifested in the treatment at a concentration of 10 ppm.

TABLE 17
Effect of Borage Extract Treatment on Water Loss Rate of Cucumber
Leaves Under Foliar Spray at Low Temperature Conditions

| | | Water | Reduction |
|---|---|---|---|
| Treatment | Concentration | Loss Rate | Rate % |
| CK | / | 41.33% | / |
| Borage extract extracted | 2 ppm | 30.40% | 26.45 |
| with 60% ethanol | 10 ppm | 26.34% | 36.27 |
| | 50 ppm | 28.96% | 29.93 |

### Test Example 6

As can be seen from Test examples 1-5, under the extraction with 60% ethanol conditions, the borage extract had significant effects on promoting growth and alleviating stress damage to germination of corn seeds, germination of rice seeds under salt-alkali conditions, growth of cucumber under foliar spray at low temperature conditions, and growth of Capsicum annuum seedlings. Therefore, the borage extract extracted with 60% ethanol was prepared into a borage extract preparation using a surfactant such as a thickener and an emulsifier, to verify the effect of the stabilizing preparations on growth of crops.

### 1. Trial Preparation of Formula for Borage Extract Preparation

The formula for preparation included: borage extract, thickener-xanthan gum, emulsifier-alkyl glycoside, defoamer, and water. The compound trial production was carried out in different proportions, and the specific formula design table was as follows:

TABLE 18
Trial Formula for Borage Extract Preparation

| | Addition proportion % | | | |
|---|---|---|---|---|
| Components | Formula 1 | Formula 2 | Formula 3 | Formula 4 |
| Borage extract | 20 | 20 | 20 | 20 |
| Dispersant | 10 | 0 | 10 | 10 |
| Thickener | 0 | 2 | 2 | 2 |
| Defoamer | 0.5 | 0.5 | 0 | 0.5 |
| Water | 69.5 | 77.5 | 68 | 67.5 |

### 2. Stability Investigation of Trial Production Formula

After the trial production of each formula, the samples were subjected to high temperature (54° C.) and low temperature (0° C.) stability storage tests. After 2 weeks of storage under cold and hot conditions, the stability of the preparation was investigated.

The results showed that Formula 1 exhibited a small amount of precipitate under hot storage conditions; in the absence of an emulsifier, the sample of Formula 2 showed obvious layering phenomenon and poor water dispersibility, the sample of Formula 3 had more foam in the dissolution process, and the preparation sample of Formula 4 was a homogeneous stable liquid with good dispersibility.

Therefore, Formula 4 was preferred as the trial production formula for borage extract.

### 3. Trial Production Process of Formula

The borage extract, a thickener, an emulsifier, a defoamer, and water were measured in a ratio of 20:10:2:0.5:67.5 for trial production of formula. The specific process operation method is as follows:
1) 2% of xanthan gum was weighed and sheared with 85.5% of water until the xanthan gum was completely dissolved and dispersed to form a homogeneous liquid for later use;
2) The liquid in step 1) was stirred at 55° C., and 20% of the borage extract was accurately weighed and added to an agitated vessel, the mixture was stirred at 55° C. for 30 minutes until the liquid was homogeneous;
3) 2% of alkyl glucoside was weighed and added to the homogeneous liquid in the above 2), stirred for 3 minutes, then 0.5% of defoamer was added and stirred for 3 minutes to complete the trial production of formula sample.

### 4. Detection Results of Borage Extract Preparation

The basic physicochemical properties and technical indicators of the borage extract preparation are shown in Table 19:

TABLE 19
Detection Results of Borage Extract Preparation

| Detection Indicators | Detection Results |
|---|---|
| pH | 5.41 |
| Water insoluble matters, % | ≤2% |
| Content of free amino acids, % | ≥2% |

After forming a stable sample of borage extract preparation, the preparation was applied for bioassay validation to clarify its application effect.

### Test Example 7

This Test example tested the effect of foliar spray of the borage extract preparation in Test Example 6 combined with a plant regulator 0.0075% brassinosteroid on growth of tomatoes and quality of fruits using pot cultivation methods. The method for using the borage extract preparation in this test example was foliage spray.

### 1. Test Method

### (1) Test Sample

The borage extract preparation prepared in Test Example 6, with an addition amount of borage extract of 20% (i.e. a concentration of borage extract of 200000 ppm) was diluted and applied according to the test design after filter sterilization.

### (2) Test Design

A total of 4 groups of treatments were designed in the test, with each group repeated 8 times. For details, please refer to Table 20.

TABLE 20
Test Design

| | | Application | Dilution Factor |
|---|---|---|---|
| Nos. | Use of Agents | Concentration | of Preparation |
| CK | Clear water | / | |
| BR | 0.0075% brassinosteroid | 0.025 ppm | 3000 times |
| JS | Borage extract preparation | 50 ppm | 4000 times |
| JS + | Borage extract preparation + | 50 ppm + | 4000 times + |
| BR | brassinosteroid | 0.025 ppm | 3000 times |

### (3) Test Treatments:

### 1) Preparation of Culture Medium

Vermiculite and coconut coir sterilized by high-pressure steam at 121° C. for 20 minutes were mixed evenly in a ratio of 2:1, and then put into a pot for later use.

2) Preparation of test materials: the seeds of tomatoes were soaked and sterilized in a 5% sodium hypochlorite solution for 10 minutes, then washed with water, and then sowed; when the tomato seedlings grew to have 4-5 leaves, seedlings of the same size, free from pests and diseases were selected, and field planted for later use.

### 3) Preparation of Agents

The borage extract preparation was diluted by 4000 times, and diluted by 3000 times with 0.0075% brassinosteroid to obtain the actual application concentration of the spraying agent.

### 4) Test Treatments

The tomato seedlings of the same size, free from pests and diseases were selected and transplanted into pots, with one seedling per pot and 8 replicates per treatment. A total of 32 pots was tested. During the tomato seedling stage (7-8 leaves), pre-flowering and fruiting-bearing stages, the agent was sprayed according to the test design. At harvest time, the growth status of tomato leaves and plant height were investigated, and tomato fruit yield was measured.

### (5) Detection Indicators

The test detection indicators included chlorophyll, plant height, flowering numbers of tomatoes, fruit setting numbers, fruit redness rate, and average yield per plant.

### 2. Result Analysis

### (1) the Effect of Spraying Borage Extract Preparation on the Growth Status of Tomatoes

As can be seen from Table 21, after the treatment with plant regulator brassinosteroid and borage extract preparation, the SPAD value of tomato leaves and tomato plant height were increased significantly compared to the clear water control, with growth rates ranging from 7.37% to 11.22% and 9.20% to 18.99%; compared with single agent treatment, after the treatment with the combination of brassinosteroid and borage extract preparation, the SPAD value of tomato leaves and tomato plant height were increased to varying degrees, the maximum increase in SPAD value was 5.07% and the maximum increase in plant height was 11.14%.

TABLE 21
Effects of Borage Extract Preparation
Treatment on Growth of Tomatoes

| | | Growth | Plant | Growth |
|---|---|---|---|---|
| Treatment | SPAD | Rate % | Height/cm | Rate % |
| CK | 31.2 | / | 33.7 | / |
| BR | 34.7 | 11.22 | 36.8 | 9.20 |
| JS | 33.5 | 7.37 | 40.1 | 18.99 |
| JS + BR | 35.2 | 12.82 | 40.9 | 21.36 |

### (2) the Effect of Borage Extract Preparation on the Growth of Tomato Fruits

As can be seen from Table 22, after the treatment with plant regulator brassinosteroid and borage extract preparation, the average flowering number and fruit setting number of tomatoes per plant were increased to varying degrees compared to clear water treatment, and all of them showed a greater increase under the treatment of borage extract preparation; similarly, the fruit redness rate of tomatoes and the average yield per plant were also increased to varying degrees, the maximum growth rates reached 24.52% and 24.66%, respectively.

Compared with single agent treatment, after the treatment with the combination of brassinosteroid and borage extract preparation, the flowering numbers of tomatoes, fruit setting numbers, fruit redness rate, and yield per plant were all increased to varying degrees, indicating that the treatment with the combination of the borage extract preparation and regulator can promote fruit growth and fruit setting of tomatoes, accelerate fruit color change rate of tomatoes, and increase fruit yield of tomatoes.

TABLE 22
Effects of Borage Extract Preparation Treatment on Growth of Tomato Fruits

| | | | Fruit | | | | Average | |
|---|---|---|---|---|---|---|---|---|
| | Flowering | Growth | Setting | Growth | Redness | Growth | Yield | Growth |
| | Number | Rate | Number | Rate | Rate | Rate | Per Plant/ | Rate |
| Treatment | Per Plant | % | Per Plant | % | % | % | g | % |
| CK | 20.0 | / | 13.3 | / | 62.8 | / | 152.5 | / |
| BR | 24.4 | 21.88 | 14.8 | 11.32 | 74.5 | 18.63 | 183.6 | 20.39 |
| JS | 26.5 | 32.50 | 15.8 | 18.87 | 78.2 | 24.52 | 190.1 | 24.66 |
| JS + BR | 28.9 | 44.38 | 16.3 | 22.64 | 82.9 | 32.01 | 202.2 | 32.59 |

### Test Example 8

This test example tested the effect of foliar spray of borage extract preparation combined with potassium dihydrogen phosphate on yield increase and quality improvement of wheats.

### 1. Test Method

### (1) Preparation of Test Samples

The borage extract preparation prepared in Test Example 6, with an addition amount of borage extract of 20% (i.e. a concentration of active substance of 200000 ppm) was diluted and applied according to the test design after filtration and sterilization.

### (2) Test Design

TABLE 23
Test Design

| | | Application | Dilution Ratio |
|---|---|---|---|
| Nos. | Test Agent | Concentration | of Mother Liquor |
| CK | Clear water | / | / |
| CK+ | Potassium dihydrogen | 666.7 ppm | 1500 times |
| | phosphate | | |
| JS | Borage extract preparation | 50 ppm | 4000 times |
| FS | Potassium dihydrogen | 666.7 ppm + | 1500 times + |
| | phosphate + | 50 ppm | 4000 times |
| | borage extract preparation | | |

3 repetitions were set for each treatment, each replicated plot was of a size of 2 m×3 m, for a total of 12 treatment plots.

### (3) Test Treatments

The agent was sprayed according to the Test design during the booting and grain-filling stages of wheats, the thousand-grain weight of wheats and plot yield were investigated at harvest time, and samples were selected for quality detection.

### 2. Result Analysis

The application of borage extract preparation at different growth stages of wheats can promote an increase in thousand-grain weight and yield. Compared with the clear water control, the thousand-grain weight was increased by 13.20%, and the yield per square meter plot was increased by 11.13%. When the borage extract preparation was applied in combination with a potassium dihydrogen phosphate foliar fertilizer product, the yield of wheats was relatively increased, the thousand-grain weight was increased from 44.6 g to 45.7 g and the yield per square meter plot was increased by 3.2 g.

TABLE 24
Effects of Borage Extract Preparation on Yield of Wheats

| | | | Yield Per | |
|---|---|---|---|---|
| | Thousand-grain | Growth | Square Meter | Growth |
| Treatment | Weight/g | Rate % | plot/g | Rate % |
| CK | 39.4 | / | 447.4 | / |
| CK+ | 42.1 | 6.85 | 482.8 | 7.91 |
| JS | 44.6 | 13.20 | 497.2 | 11.13 |
| FS | 45.7 | 15.99 | 500.4 | 11.85 |

By detecting the quality of wheat grains after different treatments, it can be seen that compared with clear water, the contents of protein and starch in the wheat grains treated with borage extract were increased significantly, and the growth rates reached 16.55% and 15.41%, respectively. After the foliar spray treatment of borage extract preparation combined with potassium dihydrogen phosphate, the quality of wheat grains was improved. Compared with the single agent treatment of borage preparation, the content of protein was increased by 3.37% and the content of starch was increased by 3.88%.

As a whole, the foliar spray of borage extract can significantly promote the increase in wheat yield and improvement in quality. When the borage extract was combined with potassium dihydrogen phosphate for the treatment, it had a synergistic effect on improving the quality of wheats.

TABLE 25
Effects of Borage Extract Preparation on Quality of Wheats

| | | Growth | | Growth |
|---|---|---|---|---|
| Treatment | Protein/% | Rate % | Starch/% | Rate % |
| CK | 11.72 | / | 64.57 | / |
| CK+ | 13.48 | 15.02 | 71.25 | 10.35 |
| JS | 13.66 | 16.55 | 74.52 | 15.41 |
| FS | 14.12 | 20.48 | 77.41 | 19.89 |

### Test Example 9

This test example tested the effect of foliar spray of borage extract preparation on yield increase and quality improvement of Brassica rapa chinensis.

### 1. Test Method

### (1) Preparation of Test Samples

The borage extract preparation prepared in Test Example 6, with an addition amount of borage extract of 20% (i.e. a concentration of active substance of 200000 ppm) was diluted and applied according to the test design after filter sterilization.

### (2) Test Design

TABLE 26
Test Design

| | | Application | Dilution Ratio |
|---|---|---|---|
| | | Concentration | of Mother |
| Nos. | Test Agent | (ppm) | Liquor |
| CK | Clear water | / | / |
| 1 | Borage extract preparation | 50 ppm | 4000 times |
| 2 | Borage extract preparation | 250 ppm | 800 times |

### (3) Test Treatments

Brassica rapa chinensis direct seeding in the open field was selected as the test crop, and the borage extract preparation was sprayed according to the test design during the seedling stage (three leaves and one heart stage) and rapid growth stage (6-7 leaves stage), and the changes in leaf color and yield of Brassica rapa chinensis were investigated at harvest time, and samples were selected for protein and vitamin C nutritional quality determination.

### 2. Result Analysis

Compared with the clear water control treatment, after the treatment with different concentrations of borage extracts, the leaves of Brassica rapa chinensis were darker green, the maximum increase in SPAD value was 21.42%, and the maximum increase in yield per square meter plot was 35.16%.

TABLE 27
Effects of Foliar Spray of Borage Extract Preparation
on Growth of Brassica Rapa Chinensis

| | | Growth | Yield Per Square | Growth |
|---|---|---|---|---|
| Treatment | SPAD | Rate % | Meter Plot/kg | Rate % |
| ck | 37.40 | / | 1.82 | / |
| JS1 | 45.41 | 21.42 | 2.14 | 17.58 |
| JS2 | 44.68 | 19.47 | 2.46 | 35.16 |

After the treatment by foliar spray of borage extract preparation, the contents of vitamin C and protein of Brassica rapa chinensis were increased to varying degrees. Among them, the quality improvement effect was better under the treatment at a concentration of 250 ppm, the content of vitamin C was increased by 23.72% and the content of protein was increased by 9.74%

TABLE 28
Effects of Foliar Spray of Borage Extracts
on Quality of Brassica Rapa Chinensis

| | Vitamin C | Growth | Protein | Growth |
|---|---|---|---|---|
| Treatment | (mg/100 g) | Rate % | (g/100 g) | Rate % |
| ck | 63.40 | / | 1.54 | / |
| JS1 | 74.15 | 16.96 | 1.67 | 8.44 |
| JS2 | 78.44 | 23.72 | 1.69 | 9.74 |

As a whole, the treatment by foliar spray of borage extract preparation can promote the growth of Brassica rapa chinensis leaves, increase the yield of Brassica rapa chinensis, meanwhile improve the quality of edible parts of Brassica rapa chinensis, and increase the contents of vitamin C and protein.

Although the examples of the present disclosure have been shown and described, for those of ordinary skill in the art, it should be understood that many changes, modifications, substitutions, and variations can be made to these examples without departing from the principles and spirit of the present disclosure, and the scope of the present disclosure is limited by the appended claims and their equivalents.

1. An application of a borage extract in promoting plant growth and/or regulating plant stress resistance.

2. The application of claim 1, wherein, the borage extract is capable of promoting seed germination and/or the growth of one or more of roots, stems, leaves, or flowers and fruits.

3. The application of claim 1, wherein, the stress resistance is at least one of salt resistance, cold resistance, drought resistance, and high temperature resistance.

4. The application of claim 1, wherein, the borage extract is an alcohol extract; further, an alcohol solution is selected from methanol or ethanol.

5. The application of claim 4, wherein, the alcohol solution is ethanol; further, the concentration of the ethanol is 10% to 100%; more further, the concentration of the ethanol is 40% to 80%.

6. The application of claim 4, wherein, the mass ratio of borage to the alcohol solution is 1-5:15-25; preferably 1:20.

7. The application of claim 1, wherein, the concentration of the borage extract is 0.001 ppm to 100 ppm; preferably 2 ppm to 50 ppm.

8. The application of claim 1, wherein, when in use, the borage extract is prepared into an agricultural product for use, which further comprises an auxiliary material comprising one or more of a thickener, a defoamer, a dispersant, a wetting agent, a binder, an emulsifier, a stabilizer, and a solvent.

9. The application of claim 8, wherein, the dosage form of the product is a powder, a granule, a water aqua, a mother liquor or a mother powder.

10. The application of claim 9, wherein, the agricultural product prepared from the borage extract is used in combination with a plant regulator, a foliage fertilizer, a water-soluble fertilizer, a compound fertilizer, and a pesticide.

11. The application of claim 10, wherein, when in use, a single agent of or an agricultural product prepared from the borage extract is used to treat seeds, spray leaves or irrigate roots.

12. A biostimulant, wherein the biostimulant comprises the borage extract as an active ingredient.

13. The application or the biostimulant of claim 1, wherein, the plant comprises tobacco leaves, corns, rices, cucumbers, asparagus lettuces, wheats, Capsicum annuums, Brassica rapa chinensis, Lactuca sativa, pakchoi cabbages, tomatoes, citrus, kiwi fruits, cherries, pears, and apples.
